(19) United States
(12) Patent Application Publication
(10) Pub. No.: US 2021/0001454 A1
(43) Pub. Date: Jan. 7, 2021

(54) CLAMP ARM ASSEMBLY

(71) Applicant: Enerpac Tool Group Corp., Menomonee Falls, WI (US)

(72) Inventor: James Adam Hefti, Burlington, WI (US)

(21) Appl. No.: 16/978,667

(22) PCT Filed: May 16, 2019
(86) PCT No.: PCT/US2019/032704

§ 371 Date: Sep. 4, 2020

Related U.S. Application Data
(60) Provisional application No. 62/672,545, filed on May 16, 2018.

(51) Int. Cl. B25B 5/06; F16B 2/24; F16B 2/06; F16B 21/18; B25B 5/16

(52) U.S. Cl. CPC B25B 5/062; F16B 2/248; B25B 5/163; F16B 21/186; F16B 2/065

(57) ABSTRACT

A clamp assembly includes a clamp member and a clip. The clamp member includes a body and an aperture. The body includes an end portion, a first arm, and a second arm. The first arm and second arm each extend from the end portion. The first arm and second arm are laterally spaced apart from one another to form an opening positioned therebetween. The opening extends along an axis. The aperture extends through the first arm and the second arm in a direction orthogonal to the axis of the opening. The aperture is positioned proximate ends of the first arm and the second arm on an opposite side of the opening relative to the end portion. The clip includes a clip body extending partially about the opening axis and securing the clamp member against axial movement relative to the plunger.

### REFERENCE TO RELATED APPLICATION

This application claims the benefit of and priority to co-pending, prior-filed U.S. Provisional Patent Application No. 62/672,545, filed May 16, 2018, the entire contents of which are incorporated by reference.

### TECHNICAL FIELD

The present disclosure relates to a work holding clamp and more specifically, to a clamp arm assembly for a work holding hydraulic swing clamp.

### SUMMARY

In one aspect, a clamp member includes a body and an aperture. The body including an end portion, a first arm, and a second arm. The first arm and the second arm each extend from the end portion, the first arm and the second arm laterally spaced apart from one another to form an opening positioned therebetween, the opening extending along an axis. The aperture extends through the first arm and the second arm in a direction orthogonal to the axis of the opening. The aperture is positioned proximate ends of the first arm and the second arm on an opposite side of the opening relative to the end portion.

In some aspects, body further includes a groove that extends at least partially along a perimeter of the opening.

In some aspects, the groove extends through an angle of between approximately 180 degrees and approximately 270 degrees about the axis of the opening.

In some aspects, the groove extends through an angle of between approximately 180 degrees and approximately 190 degrees about the axis of the opening.

In some aspects, the groove includes a channel extending through at least one of the first arm and the second arm in a direction that is substantially orthogonal with respect to the opening.

In some aspects, the first arm and the second arm are moveable toward and away from one another. Movement of the arms changes a cross-sectional area of the opening.

In some aspects, the aperture is configured to receive a fastening member. Engagement of the fastening member in the aperture causes a cross-sectional area of the opening to be reduced. The fastening member requires less than 60 foot-pounds of torque to be tightened.

In another aspect, a clip for securing a clamp arm to a rod includes a body, a first bent portion, and a second bent portion. The body includes a first end, a second end, and an arc that extends about a central axis between the first end and the second end. The first bent portion is disposed at the first end, and the second bent portion is disposed at the second end.

In some aspects, the body extends no more than 210 degrees about the central axis.

In some aspects, the body extends no more than 190 degrees about the central axis.

In some aspects, the body extends between approximately 180 degrees and 190 degrees about the central axis.

In some aspects, the first bent portion is approximately orthogonal to a portion of the body proximate the first end, and the second bent portion is approximately orthogonal to a portion of the body proximate the second end.

In some aspects, the clip is configured to engage a groove of the rod. The body exerts a biasing force to retain the body within the groove. The clip is removable from the groove upon application of a force to deflect the first bent portion and the second bent portion away from one another.

In some aspects, the body includes a first portion, a second portion, and a third portion. The second portion includes the first end and the third portion includes the second end. The second portion and the third portion are substantially linear.

In yet another aspect, a clamp arm assembly is configured to be attached to a plunger. The clamp arm assembly includes a clamp member and a clip. The clamp member includes a body and an aperture. The body includes an end portion, a first arm, and a second arm. The first arm and second arm each extend from the end portion. The first arm and second arm are laterally spaced apart from one another to form an opening positioned therebetween. The opening extends along an axis. The aperture extends through the first arm and the second arm in a direction orthogonal to the axis of the opening. The aperture is positioned proximate ends of the first arm and the second arm on an opposite side of the opening relative to the end portion. The clip includes a clip body that extends partially about the opening axis and securing the clamp member against axial movement relative to the plunger.

In some aspects, the clip body extends through an arc of no more than 270 degrees about the axis.

In some aspects, the clip body extends through an arc of approximately 180 and 190 degrees.

In some aspects, the body of the clamp member further includes a groove that extends at least partially along a perimeter of the opening. The clip body is receivable within the groove.

In some aspects, the body of the clamp member further includes channels oriented in a direction orthogonal to the opening. The clip further includes a first bent portion proximate a first end of the clip body and a second bent portion proximate a second end of the clip body. The first bent portion and the second bent portion are positionable in the channels.

In some aspects, the clamp member does not rotate relative to the clip while the clip is received within the groove.

In some aspects, the first arm and the second arm are moveable toward and away from one another. Movement of the arms changes a cross-sectional area of the opening.

Other aspects of the disclosure will become apparent by consideration of the detailed description and accompanying drawings.

### BRIEF DESCRIPTION OF THE DRAWINGS

FIG. 1 is a perspective view of a hydraulic swing clamp.

FIG. 2 is an enlarged perspective view of a clamp arm assembly coupled to a plunger.

FIG. 3 is an exploded view of the clamp arm assembly and the plunger of FIG. 2.

FIG. 4 is a perspective view of a clamp member.

FIG. 4A is a perspective view of a clamp member of another embodiment.

FIG. 4B is a top view of the clamp member of FIG. 4A.

FIG. 4C is a perspective view of a clamp member of another embodiment.

FIG. 4D is a top view of the clamp member of FIG. 4C

FIG. 5 is a perspective view of a clip.

FIG. 6 is a perspective view of a clamp member spaced apart from an end of the plunger of FIG. 2.

FIG. 7 is a perspective view of a clamp member and a clip according to another embodiment.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a clamp arm assembly for a workholding clamp (e.g., a hydraulic rotary or swing clamp). The clamp arm assembly can be secured to a plunger or rod of the clamp to provide a clamping force on a workpiece. A clip can engage the clamp member and the plunger and arms of the clamp member can be tightened onto the plunger to prevent relative movement between the clamp member and the plunger. The clip can be inserted and removed from the plunger upon application of relatively low input force, and the arms of the clamp member can be tightened onto the plunger with relatively low input torque.

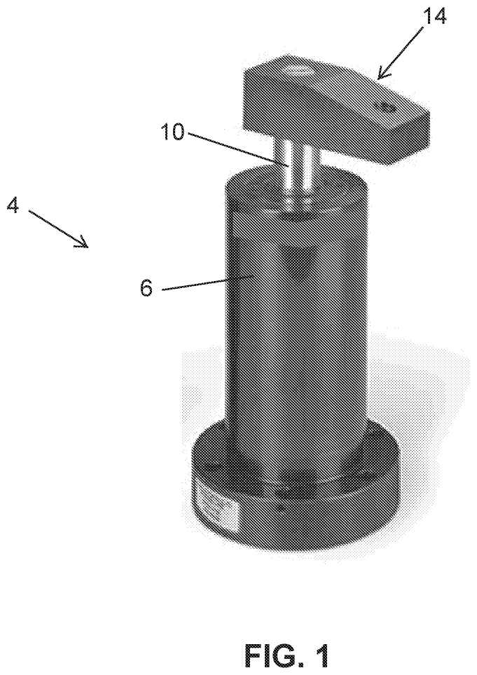

FIG. 1 illustrates a hydraulic clamp (e.g., a swing clamp) 4 including a barrel 6 and a rod or plunger 10 that is extendable relative to the barrel 6. A clamp arm assembly 14 is coupled to the plunger 10. In some applications, the clamp arm assembly 14 may be secured to an end of the plunger 10 to apply a clamping force on a workpiece.

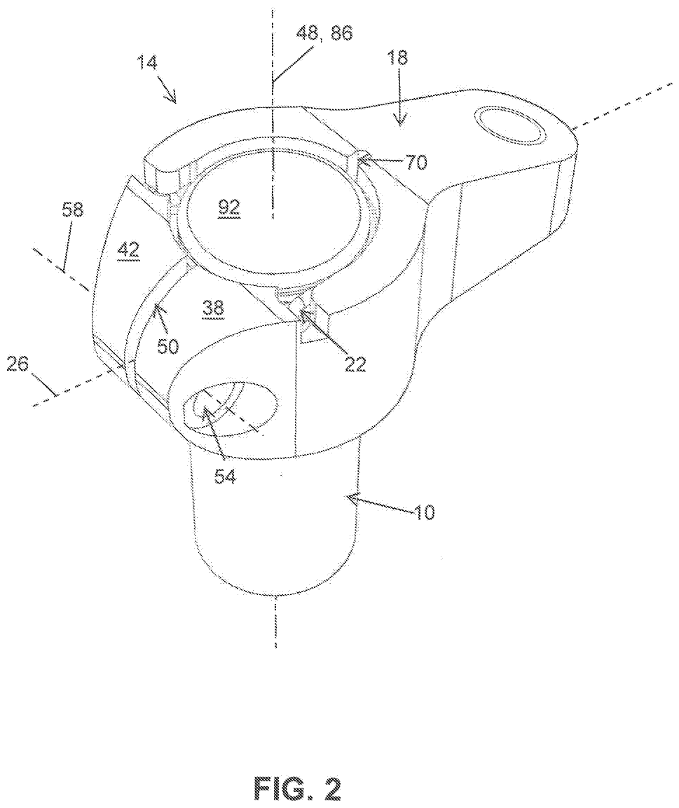

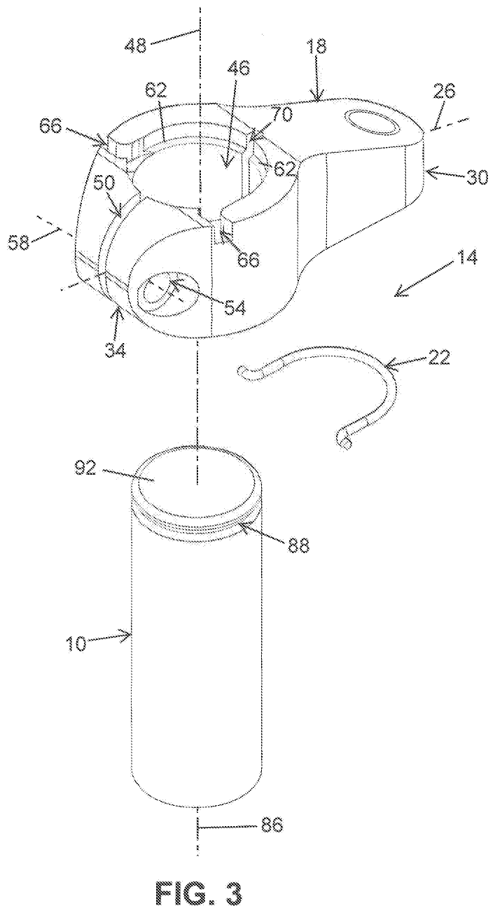

As shown in FIGS. 2 and 3, the clamp arm assembly 14 includes a clamp member or arm 18 and a clip 22. The clamp arm 18 extends along a longitudinal axis 26 between a first end 30 (FIG. 3) and a second end 34. In the illustrated embodiment, the first end 30 is rounded. The clamp arm 18 includes a first arm 38 (FIG. 2) and a second arm 42 that each extend at least partially along the longitudinal axis 26. In the illustrated embodiment, an inner surface of each of the arms 38, 42 (that is, the surface of the arms 38, 42 facing one another) extends along a curvilinear path.

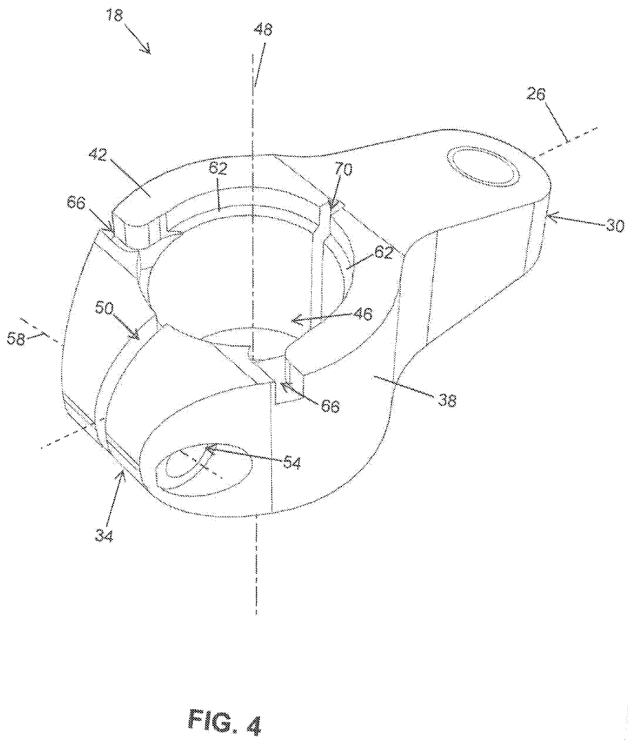

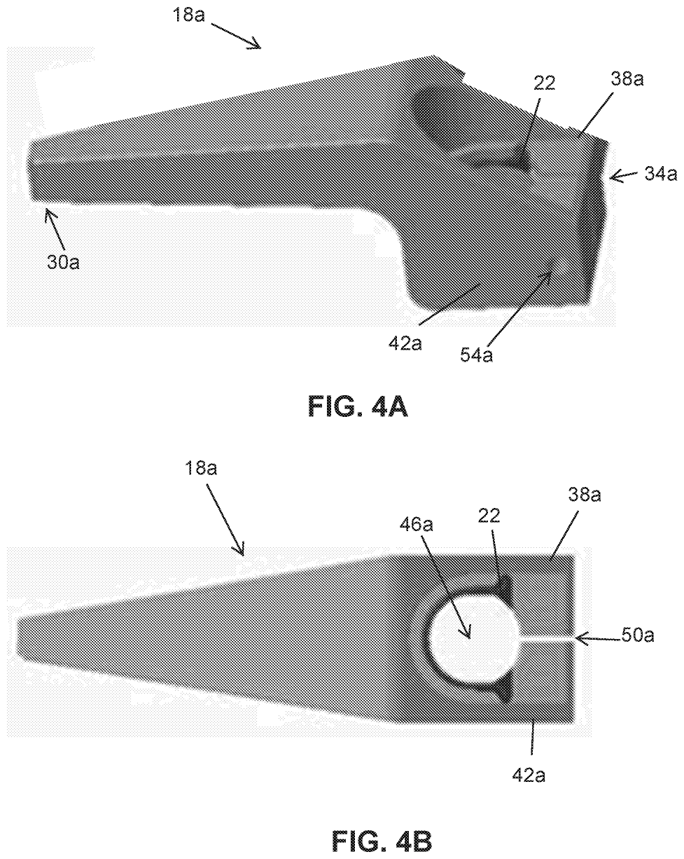

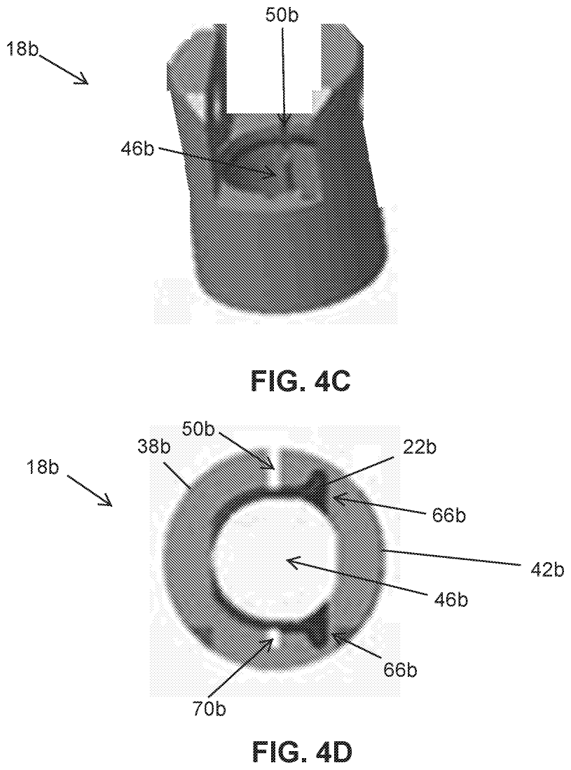

Referring to FIG. 4, the arms 38, 42 together define a substantially circular opening 46 extending along an opening axis 48, substantially orthogonal with respect to the longitudinal axis 26. In the illustrated embodiment, the arms 38, 42 do not fully enclose the opening 46. An end of the first arm 38 is spaced apart from an end of the second arm 42 by a slot or gap 50 disposed between the ends of the arms 38, 42. The gap 50 extends between an outer surface of the arms 38, 42 and the opening 46, parallel to the longitudinal axis 26.

An aperture 54 extends through both arms 38, 42 proximate the second end 34. That is, the aperture 54 is positioned on an opposite side of the opening 46 from the first end 30 of the arm 18. In the illustrated embodiment, the aperture 54 extends along an aperture axis 58 that is orthogonal to and offset from the longitudinal axis 26. Stated another way, a plane containing the aperture axis 58 is orthogonal with respect to the opening axis 48.

A groove (e.g., a chamfer counter bore) 62 extends along an inner surface of each of the arms 38, 42 (i.e., the surface of the arms 38, 42 proximate the opening 46). In the illustrated embodiment, the chamfer counter bore 62 extends entirely along a perimeter of the opening 46, and each chamfer counter bore 62 includes a channel 66. Each channel 66 is spaced apart from the end of the respective arm 38, 42 and is spaced apart from the gap 50 between the ends of the arms 38, 42. In the illustrated embodiment, a center of each channel 66 is spaced apart from a center of the gap 50 by an angle about the opening axis 48. In some embodiments, the angle is approximately 60 degrees; in other embodiments, the angle may be greater or less than 60 degrees.

Also, in the illustrated embodiment, a slot 70 is disposed between the arms 38, 42 proximate the first end 30 of the body 18, opposite the gap 50. The slot 70 extends parallel to the opening axis 48. The slot 70 also creates a discontinuity in the chamfer counter bore 62 between the first arm 38 and the second arm 42.

FIGS. 4A and 4B illustrate clamp arm 18a, and FIGS. 4C and 4D illustrate clamp arm 18b. The clamp arms 18a and 18b are similar to the clamp arm 18. Similar features are identified with a similar reference number, plus the letter “a” or the letter “b,” respectively.

As shown in FIGS. 4A and 4B, the first end 30a and the second end 30b are angled (i.e., edges of the first and second ends 30a, 34a have corners). Additionally, the clamp arm 18a does not extend along a single axis. The first end 30a is offset from the second end 34a relative to the opening axis 48 (e.g., the first end 30a is positioned on a separate plane from the second end 34a).

As shown in FIGS. 4C and 4D, the clamp arm 18b has a generally cylindrical shape and does not include a first end or a second end. In the illustrated embodiment, centers of channels 66b are oriented offset from the center of channels 66. The center of one channel 66b is disposed proximate the gap 50b, and the center of the other channel may be disposed proximate the slot 70b. In the illustrated embodiment, the channels 66b are offset about 90 degrees with respect to an axis extending between the opening axis and the gap 50b (i.e., 90 degrees offset relative to the orientation of the channels 66 in FIG. 4).

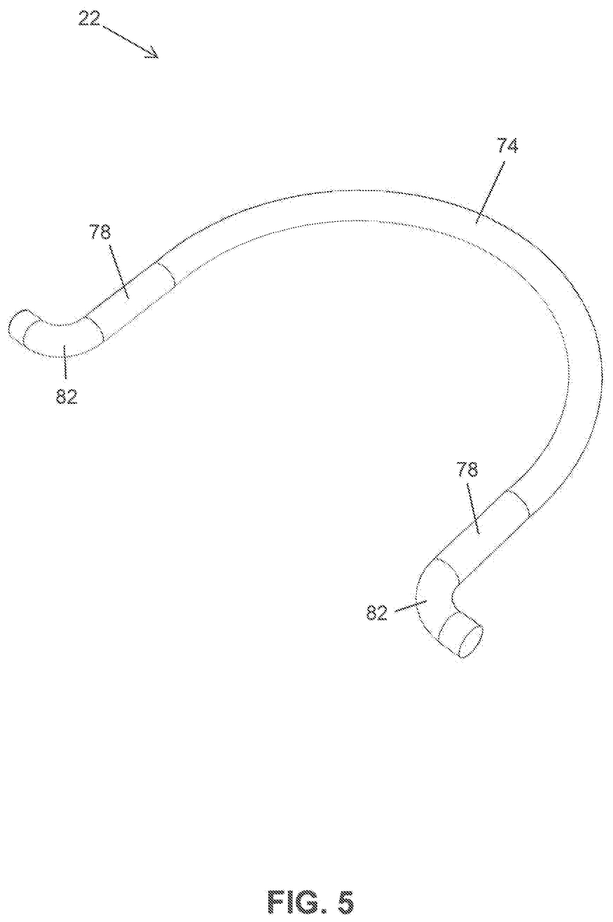

As shown in FIG. 5, the clip 22 includes a first portion 74 that extends along a substantially curvilinear path. In some embodiments, the first portion 74 extends through an angle that is greater than 180 degrees and less than 270 degrees about a central axis orthogonal to the plane of the first portion 74. In other embodiments, the first portion 74 extends through an angle that is greater than 180 degrees and less than 260 degrees. In other embodiments, the first portion 74 extends through an angle that is greater than 180 degrees and less than 250 degrees. In other embodiments, the first portion 74 extends through an angle that is greater than 180 degrees and less than 240 degrees. In other embodiments, the first portion 74 extends through an angle that is greater than 180 degrees and less than 230 degrees. In other embodiments, the first portion 74 extends through an angle that is greater than 180 degrees and less than 220 degrees. In other embodiments, the first portion 74 extends through an angle that is greater than 180 degrees and less than 210 degrees. In other embodiments, the first portion 74 extends through an angle that is greater than 180 degrees and less than 200 degrees. In other embodiments, the first portion 74 extends through an angle that is greater than 180 degrees and less than 190 degrees. In other embodiments, the first portion 74 extends through an angle that is greater than 180 degrees and less than 185 degrees.

The clip 22 further includes second portions 78, each of which is positioned adjacent an end of the first portion 74. In the illustrated embodiment, the second portions 78 are substantially linear. Bent portions or wings or third portions 82 are positioned adjacent the ends of the second portions 78. In the illustrated embodiment, the third portions 82 have an L-shaped bend relative to the associated second portion 78, and the third portions 82 bend away from each other and/or away from the orthogonal axis (i.e., the third portions 82 angle away from the orthogonal axis in a horizontal direction). In other embodiments (not shown), the third portions 82 may be oriented parallel to the orthogonal axis (i.e., the third portions 82 bend in a vertical direction). In some embodiments, both of the third portions 82 may be oriented in the same direction (i.e., both upwardly or both downwardly), or the third portions 82 may be oriented in opposite directions (i.e., one upwardly and one downwardly).

As shown in FIG. 2, the clamp arm 18 and the clip 22 are coupled to the plunger 10. A diameter of the opening 46 (FIG. 3) is slightly larger than a diameter of the plunger 10, which allows the opening 46 to receive the plunger 10, and also allows the clamp arm 18 to slide along the plunger 10. A plunger axis 86 and the opening axis 48 are coincident while the opening 46 receives the plunger 10. The clamp arm 18 may slide along the plunger axis 86, and may rotate about the plunger axis 86 to a desired position/orientation.

Referring again to FIG. 3, the plunger 10 includes a groove 88 that extends around a circumference of the plunger 10. In the illustrated embodiment, the groove 88 is disposed proximate a plunger end 92. The first portion 74 of the clip 22 has a radius slightly smaller than a radius of the groove 88, and the clip 22 fits securely within the groove 88.

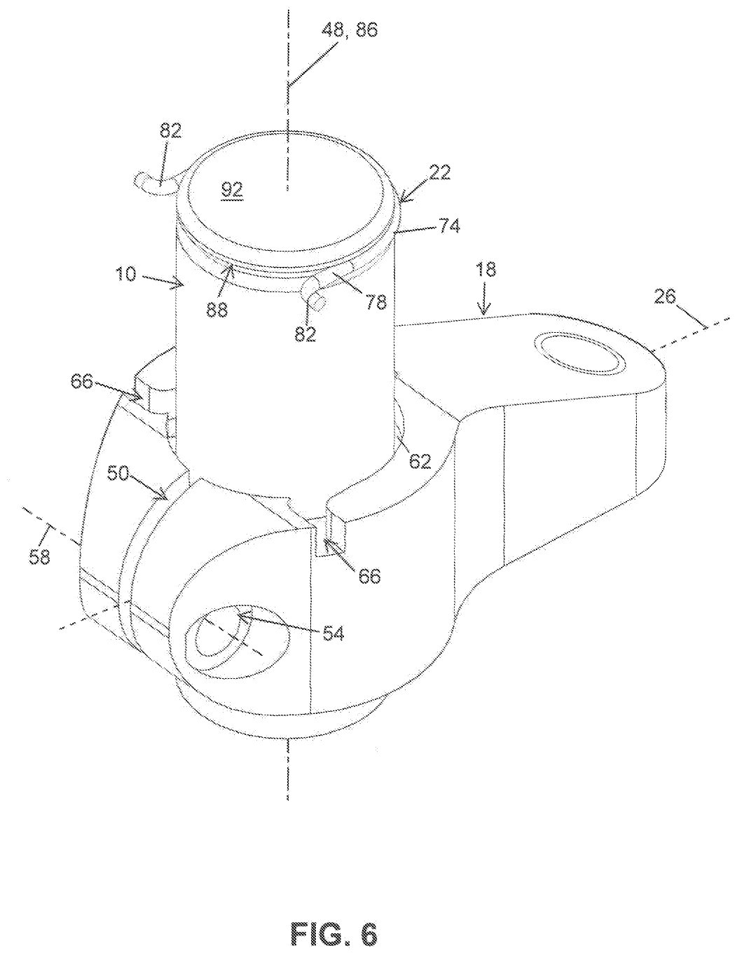

When assembling the clamp assembly 14 on the plunger 10, a user first slides the clamp arm 18 onto the plunger 10 and away from the plunger end 92. While in an untightened state, the clamp arm 18 is fully translatable along the plunger axis 86 and fully rotatable about the plunger axis 86. Next, the user positions the clip 22 into the groove 88 on the plunger 10, so that the clip 22 snaps into the groove 88 (FIG. 6). The first portion 74 of the clip 22 has a slightly smaller diameter than a diameter of the groove 88. A biasing force caused by the smaller diameter of the first portion 74 engaging the groove 88 secures the clip 22 to the plunger 10. As shown in FIG. 6, only the first portion 74 of the clip 22 contacts the groove 88. The second portions 78 extend substantially tangential to the groove 88 and the third portions 82 are angled away from the groove 88. The first portion 74 provides a biasing force to retain the clip 22 within the groove 88, but the angular length of the first portion 74 creates a lower biasing force than a clip in which a curved section extends through an angle that is significantly more than 190 degrees about the axis.

The clip 22 is substantially the same shape as the chamfer counter bore 62 on the arms 38, 42. As the clamp arm 18 is moved toward the groove 88, the clip 22 is positioned within the chamfer counter bore 62. The clip 22 is fixed to the plunger 10 along the plunger axis 86 and prevents the clamp arm 18 from being removed from the plunger 10. Thus, the clip 22 engaging the plunger groove 88 provides an axial stop for the clamp arm 18. Additionally, each wing 82 fits within one of the channels 66 so that when the clip 22 is received within the channels 66, the clamp arm 18 cannot rotate relative to the clip 22. The channels 66 align the clip 22 with the clamp arm 18.

Returning the FIG. 2, a fastening member (e.g., a bolt—not shown) is inserted into the aperture 54 through the arms 38, 42. In some embodiments, the aperture 54 may include a fine thread (not shown) engaging the fastening member. Tightening the fastening member reduces a size of the gap 50 along the axis 58, until the ends of the respective arms 38, 42 contact one another. The slot 70 allows the arms 38, 42 to deflect toward one another so that the gap 50 can close. As the gap 50 closes, the cross-sectional area of the opening 46 shrinks and becomes approximately equivalent to the diameter of the plunger 10, thereby preventing rotational movement of the clamp arm 18 about the plunger axis 86 and preventing translational movement away from the plunger end 92.

Providing the apertures 54 proximate the second end 34 of the clamp arm 18 reduces the torque needed to tighten the fastening member to the clamp arm 18. Clamp arms with fasteners positioned intermediately between the ends of the clamp arm require a substantial amount of torque (in some cases, over 270 foot-pounds) to tighten because tightening the fastening member squeezes the entire clamp arm. By disposing the apertures proximate the second end 34, tightening the fastening member squeezes the arms 38, 42 together, but does not squeeze the entire clamp arm 18 together. Thus, the clamp arm 18 can be tightened by applying significantly less torque to the fastening member. In some embodiments, the clamp arm can be secured to the plunger 10 by applying less than 100 foot-pounds of torque to the fastening member; in some embodiments, the clamp arm can be secured to the plunger 10 by applying approximately 50 foot-pounds of torque to the fastening member.

When removing the clamp arm assembly 14 from the plunger 10, the fastening member can be first loosened by applying a torque (in some embodiments, approximately 50 foot-pounds). Once the fastening member is sufficiently loosened, the clamp arm 18 is moved away from the plunger end 92 so that the clip 22 is no longer positioned within the chamfer counter bore 62 (FIG. 3). A user then applies a force to move the bent portions or wings 82 apart from one another, creating a gap through which the clip 22 may be removed from the plunger groove 88. A biasing force of the first portion 74 (which maintained the clip 22 in the plunger groove 88) can be overcome without requiring application of substantial separating force. Since the first portion 74 extends through an angle between approximately 180 degrees and 190 degrees about the plunger axis 86, the clip 22 slides out of the groove 88 without ejecting in a forceful manner. Simple removal of the clip 22 enables a user to more easily insert and remove the clip 22 even though the plunger 10 may be greasy or slippery, a condition that makes the clip 22 difficult to handle. The wings 82 also provide ergonomic benefits, allowing the user to comfortably and easily remove the clip 22.

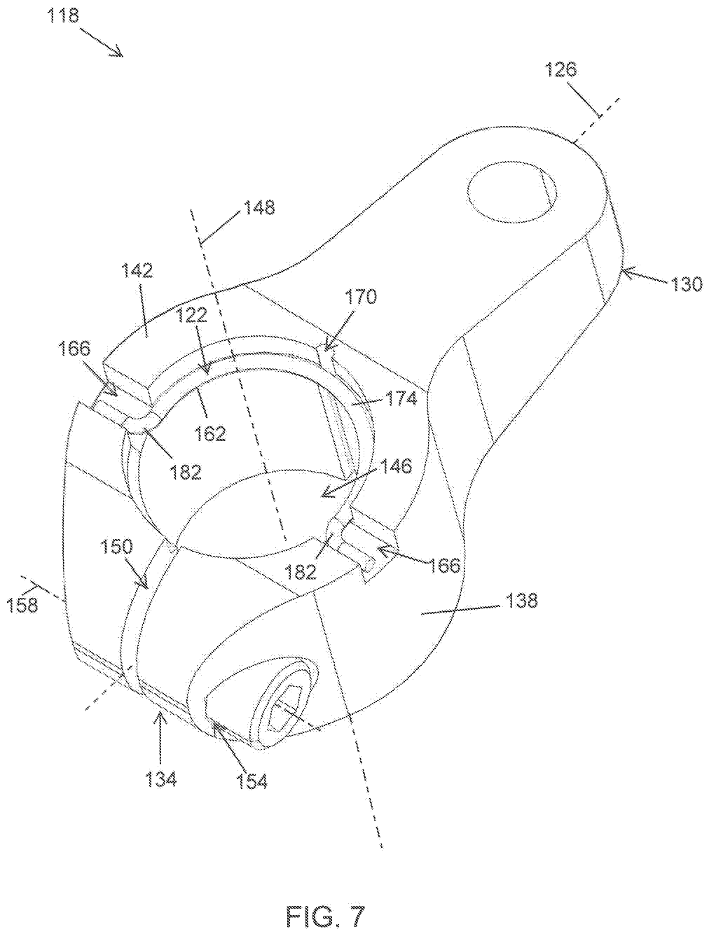

FIG. 7 illustrates a clamp arm 118 and a clip 122 according to another embodiment. The clamp arm 118 is similar to the clamp arm 18 and the clip 122 is similar to the clip 22. Similar features are identified with a similar reference number, plus “100”. Some similarities and differences between the clamp arm 18 and the clamp arm 118 are described herein. Additionally, some similarities and differences between the clip 22 and the clip 122 are described herein.

A groove (e.g., a chamfer counter bore) 162 extends along an inner surface of a pair of arms 138, 142 (i.e., along a surface of the arms 138, 142 adjacent an opening 146) of the clamp arm 118. In the illustrated embodiment, the chamfer counter bore 162 extends along a perimeter of the opening 146, and each chamfer counter bore 162 includes a channel 166. Each channel 166 is spaced apart from the end of the respective arm 138, 142 and is spaced apart from a gap 150 between the ends of the arms 138, 142. In the illustrated embodiment, a center of each channel 166 is spaced apart from a center of the gap 150 by an angle about an opening axis 148. In some embodiments, the angle is approximately 85 degrees; in other embodiments, the angle may be greater or less than 85 degrees.

The clip 122 includes a first portion 174 having a substantially curvilinear shape. In some embodiments, the first portion 174 is positioned in a plane and extends through an angle about a central axis that is oriented orthogonal to the plane. In some embodiments, the angle is greater than 180 degrees and less than 270 degrees. In other embodiments, the first portion 174 extends through an angle that is greater than 180 degrees and less than 260 degrees. In other embodiments, the first portion 174 extends through an angle that is greater than 180 degrees and less than 250 degrees. In other embodiments, the first portion 174 extends through an angle that is greater than 180 degrees and less than 240 degrees. In other embodiments, the first portion 174 extends through an angle that is greater than 180 degrees and less than 230 degrees. In other embodiments, the first portion 174 extends through an angle that is greater than 180 degrees and less than 220 degrees. In other embodiments, the first portion 174 extends through an angle that is greater than 180 degrees and less than 210 degrees. In other embodiments, the first portion 174 extends through an angle that is greater than 180 degrees and less than 200 degrees. In other embodiments, the first portion 174 extends through an angle that is greater than 180 degrees and less than 190 degrees. In other embodiments, the first portion 174 extends through an angle that is greater than 180 degrees and less than 185 degrees.

Bent portions or wings or third portions 182 are positioned adjacent the ends of the first portion 174. In the illustrated embodiment, the wings 182 have an L-shaped bend relative to the associated side of the first portion 174, and the wings 182 bend away from each other and/or away from the orthogonal axis (i.e., the wings 182 angle away from the orthogonal axis in a horizontal direction). In other embodiments (not shown), the wings 182 may be oriented non-parallel to the plane of the first portion 174 (i.e., the third portions 182 are oriented in a vertical direction, or at an acute angle relative to the plane of the first portion 174). In some embodiments, both of the wings 182 may be oriented in the same direction (i.e., both upwardly or both downwardly), or the wings 182 may be oriented in opposite directions (i.e., one upwardly and one downwardly).

The clamp arm 118 and the clip 122 can be coupled to a plunger 10 (see e.g., FIG. 2) in substantially the same manner as the clamp arm 18 and the clip 22. The clip 122 engages the groove 88 of the plunger 10 (FIG. 3). As the clamp arm 118 is moved toward the groove 88, the clip 122 is positioned within the chamfer counter bore 162. The clip 122 is fixed to the plunger 10 along the plunger axis 86 (FIG. 3) and prevents the clamp arm 118 from being removed from the plunger 10. Thus, the clip 122 engaging the plunger groove 88 provides an axial stop for the clamp arm 118. Additionally, each wing 182 fits within one of the channels 166, inhibiting the clamp arm 118 from rotating relative to the clip 122. The channels 166 align the clip 122 with the clamp arm 118.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

What is claimed is:

1. A clamp arm assembly configured to be attached to a plunger, the clamp arm assembly comprising:
a clamp member including,
a body including an end portion, a first arm, and a second arm, the first arm and second arm each extending from the end portion, the first arm and second arm laterally spaced apart from one another to form an opening positioned therebetween, the opening extending along an axis, and
an aperture extending through the first arm and the second arm in a direction orthogonal to the axis of the opening, the aperture positioned proximate ends of the first arm and the second arm on an opposite side of the opening relative to the end portion; and
a clip including a clip body extending partially about the opening axis, the clip securing the clamp member against axial movement relative to the plunger.

2. The clamp arm assembly of claim 1, wherein the clip body extends through an arc of no more than 270 degrees about the axis.

3. The clamp arm assembly of claim 2, wherein the clip body extends through an arc of approximately 180 degrees and approximately 190 degrees.

4. The clamp arm assembly of claim 1, wherein the body of the clamp member further includes a groove extending at least partially along a perimeter of the opening, the clip body receivable within the groove.

5. The clamp arm assembly of claim 4, wherein the body of the clamp member further includes channels oriented in a direction orthogonal to the opening, wherein the clip further includes a first bent portion proximate a first end of the clip body and a second bent portion proximate a second end of the clip body, the first bent portion and the second bent portion being positionable in the channels.

6. The clamp arm assembly of claim 4, wherein the clamp member does not rotate relative to the clip while the clip is received within the groove.

7. The clamp arm assembly of claim 1, wherein the first arm and the second arm are moveable toward and away from one another, movement of the arms changing a cross-sectional area of the opening.

8. A clamp member comprising:
a body including an end portion, a first arm, and a second arm, the first arm and second arm each extending from the end portion, the first arm and second arm laterally spaced apart from one another to form an opening positioned therebetween, the opening extending along an axis; and
an aperture extending through the first arm and the second arm in a direction orthogonal to the axis of the opening, the aperture positioned proximate ends of the first arm and the second arm on an opposite side of the opening relative to the end portion.

9. The clamp member of claim 8, wherein the body further includes a groove extending at least partially along a perimeter of the opening.

10. The clamp member of claim 9, wherein the groove extends through an angle of between approximately 180 degrees and approximately 270 degrees about the axis of the opening.

11. The clamp member of claim 10, wherein the groove extends through an angle of between approximately 180 degrees and approximately 190 degrees about the axis of the opening.

12. The clamp member of claim 9, wherein the groove includes a channel extending through at least one of the first arm and the second arm in a direction substantially orthogonal with respect to the opening.

13. The clamp member of claim 8, wherein the first arm and the second arm are moveable toward and away from one another, movement of the arms changing a cross-sectional area of the opening.

14. The clamp member of claim 8, wherein the aperture is configured to receive a fastening member, engagement of the fastening member in the aperture causing a cross-sectional area of the opening to be reduced, the fastening member requiring less than 60 foot-pounds of torque to be tightened.

15. A clip for securing a clamp arm to a rod, the clip comprising:
a body including a first end, a second end, and an arc extending about a central axis between the first end and the second end;
a first bent portion disposed at the first end; and
a second bent portion disposed at the second end.

16. The clip of claim 15, wherein the body extends no more than 210 degrees about the central axis.

17. The clip of claim 16, wherein the body extends no more than 190 degrees about the central axis.

18. The clip of claim 17, wherein the body extends between approximately 180 degrees and 190 degrees about the central axis.

19. The clip of claim 15, wherein the first bent portion is approximately orthogonal to a portion of the body proximate the first end, and the second bent portion is approximately orthogonal to a portion of the body proximate the second end.

20. The clip of claim 15, wherein the clip is configured to engage a groove of the rod, the body exerting a biasing force to retain the body within the groove, wherein the clip is removable from the groove upon application of a force to deflect the first bent portion and the second bent portion away from one another.

21. The clip of claim 15, wherein the body includes a first portion, a second portion, and a third portion, the second portion including the first end and the third portion including the second end, and the second portion and the third portion being substantially linear.
